(19) United States
(12) Patent Application Publication
(10) Pub. No.: US 2024/0363890 A1
(43) Pub. Date: Oct. 31, 2024

(54) LITHIUM-ION RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Ryotaro SAKAI, Hamamatsu-shi (JP); Kentaro SUZUKI, Kariya-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/645,192

(22) Filed: Apr. 24, 2024

(30) Foreign Application Priority Data
Apr. 27, 2023 (JP) 2023-073657

(51) Int. Cl. H01M 10/04; H01M 4/02; H01M 10/0525

(52) U.S. Cl. CPC H01M 10/0481; H01M 10/0525; H01M 2004/021

(57) ABSTRACT

A lithium-ion rechargeable battery includes an electrode body including a stack of a cathode plate having a cathode mixture layer, an anode plate having an anode mixture layer, and a separator arranged between the anode plate and the cathode plate. A porosity PP of the cathode mixture layer and a porosity NP of the anode mixture layer are set to be greater than a porosity SP of the separator.

### CROSS-REFERENCE TO RELATED APPLICATIONS

This application is based upon and claims the benefit of priority from prior Japanese Patent Application No. 2023-073657, filed on Apr. 27, 2023, the entire contents of which are incorporated herein by reference.

### BACKGROUND

### 1. Field

The following description relates to a lithium-ion rechargeable battery, and, more particularly, to a lithium-ion rechargeable battery that reduces high rate deterioration.

### 2. Description of Related Art

A lithium-ion rechargeable battery is light in weight and has high energy density. Further, a lithium-ion rechargeable battery that generates high voltage and high output can be used as a high-output power supply that is mounted on a vehicle and undergoes high rate charging and discharging. Such a nonaqueous electrolyte rechargeable battery includes an electrode body having an electric energy storing element. The electric energy storing element includes a cathode plate, a anode plate, and a separator insulating the cathode and anode plates. The separator facilitates the movement of lithium ions between the cathode and anode.

With respect to the porosity of such an electrode body, for example, Japanese Laid-Open Patent Publication No. 2014-120214 describes a nonaqueous electrolyte rechargeable battery that reduces the deposition of substances derived from a charge carrier by coating the surface of the anode active material. That is, the battery includes a heat-resistant layer to prevent internal short-circuiting between the separator and at least either one of the cathode and the anode caused by thermal contraction of the separator. In this case, the void fraction of the anode mixture layer, the void fraction of the separator, and the void fraction of the heat-resistant layer satisfy a predetermined relationship.

Japanese Laid-Open Patent Publication No. 2014-120214 focuses on such void fractions, or porosities, and reduces the deposition of substances derived from the charge carrier.

In a lithium-ion rechargeable battery used to drive a battery electric vehicle, a hybrid electric vehicle, or the like, electrolyte moves greatly when high rate charging or discharging is performed such as during rapid charging or when the vehicle accelerates or decelerates suddenly. When the nonaqueous electrolyte solution is not able to move thoroughly in the lithium-ion rechargeable battery (battery cell), the concentration of the nonaqueous electrolyte solution will become uneven. This may cause deterioration of the battery, namely, “high rate deterioration.” The invention of Japanese Laid-Open Patent Publication No. 2014-120214 focuses on the porosity but does not address high rate deterioration. Thus, the invention of Japanese Laid-Open Patent Publication No. 2014-120214 cannot reduce high rate deterioration.

When charging or discharging is performed at a high rate, the concentration of lithium ions may become uneven due to the porosities of the cathode, the anode, and the separator. The uneven lithium ion concentration has a tendency to result in high rate deterioration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lithium-ion rechargeable battery includes an electrode body including a stack of a cathode plate having a cathode mixture layer, an anode plate having an anode mixture layer, and a separator arranged between the anode plate and the cathode plate. A porosity PP of the cathode mixture layer and a porosity NP of the anode mixture layer are set to be greater than a porosity SP of the separator.

In the lithium-ion rechargeable battery, a difference PPD is a difference between the porosity PP of the cathode mixture layer and the porosity SP of the separator, a difference NPD is a difference between the porosity NP of the anode mixture layer and the porosity SP of the separator, and a difference ΔP, which is a difference between the difference PPD and the difference NPD, is 4% or less.

In the lithium-ion rechargeable battery, the difference PPD may be 2.00% to 6.59%

In the lithium-ion rechargeable battery, the difference NPD may be 3.96% to 7.86%.

In the lithium-ion rechargeable battery, the porosity SP of the separator may be 42.15% or less and 39.54% or greater.

In the lithium-ion rechargeable battery, the porosity PP of the cathode mixture layer may be 44.16% or greater and 48.61% or less.

In the lithium-ion rechargeable battery, the porosity NP of the anode mixture layer may be 45.38% or greater and 49.88% or less.

In the lithium-ion rechargeable battery, the density of the anode mixture layer may be 2.9 g/cm³ or less and 2.2 g/cm³ or greater.

In the lithium-ion rechargeable battery, the density of the cathode mixture layer may be 1.2 g/cm³ or less and 0.9 g/cm³ or greater.

In the lithium-ion rechargeable battery, a load cell presses the lithium-ion rechargeable battery with a load of 9.8 kN in a thickness direction of the lithium-ion rechargeable battery and the load is then changed to 4.5 kN, a displacement amount in this state is represented by D mm, the load of the load cell when the load cell is held in place and the lithium-ion rechargeable battery is left standing for 600 seconds is represented by L kN, and when a spring constant of the lithium-ion rechargeable battery represented by C kN/mm is set to be C=(9.8-L)/D, C≤95.38 kN/mm is satisfied, and C≥84.96 kN/mm is satisfied.

Other features and aspects will be apparent from the following detailed description, the drawings, and the claims.

### BRIEF DESCRIPTION OF THE DRAWINGS

FIG. 1 is a schematic perspective view showing the structure of a lithium-ion rechargeable battery.

FIG. 2 is a schematic diagram showing the structure of a rolled electrode body.

FIG. 3 is a schematic diagram showing the lithium-ion rechargeable battery in a non-energized state.

FIG. 4 is a schematic diagram showing the lithium-ion rechargeable battery when being charged.

FIG. 5 is a schematic diagram showing the lithium-ion rechargeable battery when being discharged.

FIG. 6 is a table showing the conditions and results of experiments.

FIG. 7 is a graph showing the relationship of a spring constant and a high rate characteristic index in the experiments.

FIG. 8 is a schematic diagram showing a conventional lithium-ion rechargeable battery in a non-energized state.

FIG. 9 is a schematic diagram showing the conventional lithium-ion rechargeable battery when being charged.

FIG. 10 is a schematic diagram showing the conventional lithium-ion rechargeable battery when being discharged.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Present Embodiment

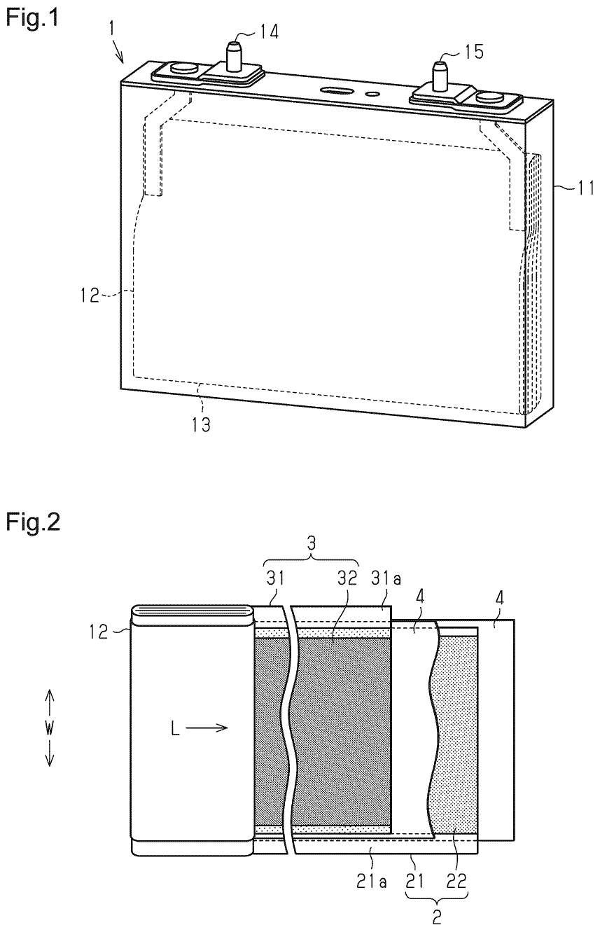

An exemplary embodiment of a lithium-ion rechargeable battery according to the present invention will now be described with reference to FIGS. 1 to 10.

### Porosity P (%)

“The porosity P (%)” as referred to in the present embodiment will first be defined. “The porosity P (%)” is a measure of the ratio of the volume (capacity) space between particles, such as gaps and voids, to the total volume. The porosity P (%) usually has a correlation with the coefficient of permeability or the like. Thus, the porosity P (%), namely, the porosity PP (%) of a cathode mixture layer 32, the porosity NP (%) of an anode mixture layer 22, and the porosity SP (%) of a separator 4 are used as indexes indicating the circulation efficiency of the lithium ions Li⁺ in the present embodiment. The void fraction (%) may also be used as such an index for a porous material like the separator 4. In the present disclosure, the porosity P (%) will be used as the index.

The porosity P (%) is measured through, for example, a liquid immersion method that immerses a porous sample into a liquid having satisfactory wettability and saturates the voids. The porosity P (%) may also be measured through an optical method that uses a microscope to observe a cross section of a sample and determine the substance area and the area of visual voids. Further, the porosity P (%) may be measured through a mercury intrusion method that measures the penetrated amount of mercury, which has strong surface tension, into pores with respect to external pressure to obtain the distribution of pores and the capacity of pores.

### Problems of Prior Art

As described in the Related Art section, when a conventional lithium-ion rechargeable battery 101 (battery cell) for a vehicle is charged or discharged at a high rate, the electrolyte containing lithium ions Li⁺ moves greatly. When the nonaqueous electrolyte solution is not able to move thoroughly in the battery cell, the concentration of the lithium ions Lit in the nonaqueous electrolyte solution 13 will become uneven. When the concentration of lithium ions Li⁺ becomes uneven, the internal resistance increases. Further, uneven current density (A/mm²) will cause the deposition of lithium metal. High rate charging or discharging causes uneven concentration of lithium ions Li⁺ that results in “high rate deterioration.”

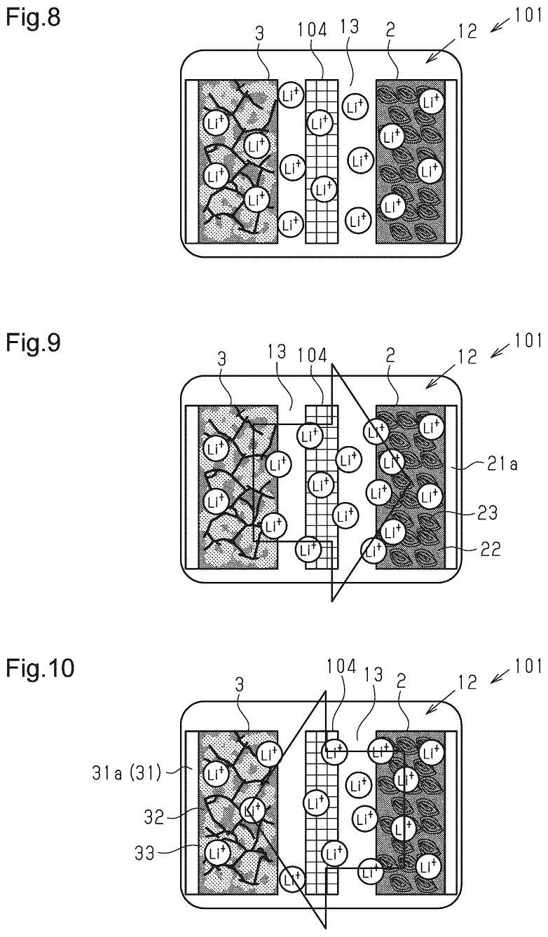

FIG. 8 shows a state in which the conventional lithium-ion rechargeable battery 101 is in a non-energized state. In the same manner as a lithium-ion rechargeable battery 1 shown in FIG. 2, the lithium-ion rechargeable battery 101 includes an electrode body 12 in which a cathode plate 3 and an anode plate 2 face each other with a separator 104 located in between. The space between the cathode plate 3 and the anode plate 2 is filled with a nonaqueous electrolyte solution 13 to allow for movement of the lithium ions Lit. In the non-energized state, the lithium ions Li⁺ are not electrically induced to any one of the cathode plate 3 and the anode plate 2.

FIG. 9 shows a state in which the conventional lithium-ion rechargeable battery 101 is charged. When the lithium-ion rechargeable battery 101 is charged, electrons are transferred from an anode connector 21a to an anode collector 21 in the anode plate 2. The electrons from the anode collector 21 are transferred to an anode active material 23. This attracts the lithium ions Lit in the nonaqueous electrolyte solution 13 toward the anode active material 23.

The porosity SP (%) of the conventional separator 104 is set to sufficiently allow for smooth movement of the lithium ions Lit. Thus, the lithium ions Lit can easily move from the cathode plate 3 toward the anode plate 2.

A sufficient amount of the anode active material 23 is included in the anode mixture layer 22 of the anode plate 2 to increase the battery capacity. Thus, the porosity NP (%) is less than that of the separator 104. This increases the concentration of lithium ions Li⁺ in the surface of the anode mixture layer 22 during charging. Thus, the concentration of lithium ions Lit has a tendency to becoming uneven. As a result, high rate deterioration has tendency to occur.

FIG. 10 is a schematic diagram that shows a state in which the conventional lithium-ion rechargeable battery 101 is discharged. When the lithium-ion rechargeable battery 101 is discharged, electrons are transferred from a cathode connector 31a to a cathode collector 31 of the cathode plate 3. The electrons from the cathode collector 31 are transferred to the cathode active material 33. This attracts the lithium ions Li⁺ in the nonaqueous electrolyte solution 13 toward the cathode active material 33.

The porosity SP (%) of the conventional separator 104 is set to sufficiently allow for smooth movement of the lithium ions Lit. Thus, the lithium ions Lit can easily move from the anode plate 2 toward the cathode plate 3.

A sufficient amount of the cathode active material 33 is included in the cathode mixture layer 32 of the cathode plate 3 to increase the battery capacity. Thus, the porosity PP (%) is lower than that of the separator 104. This increases the concentration of lithium ions Lit in the surface of the cathode mixture layer 32. Thus, the concentration of lithium ions Li⁺ has a tendency to becoming uneven. As a result, high rate deterioration has tendency to occur during discharging in the same manner as during charging.

### Features of Present Embodiment

The lithium-ion rechargeable battery 1 of the present embodiment is in contrast with the related art in that the porosity SP (%) of the separator 4 is less than the porosity PP (%) of the cathode mixture layer 32 and the porosity NP (%) of the anode mixture layer 22. This hinders movement of the lithium ions Li⁺ through the separator 4. Thus, the separator 4 limits movement of the lithium ions Lit. As a result, the distribution of the lithium ions Li⁺ is averaged throughout the nonaqueous electrolyte solution 13. This keeps the concentration of lithium ions Li⁺ uniform in the nonaqueous electrolyte solution 13. As a result, high rate deterioration is reduced.

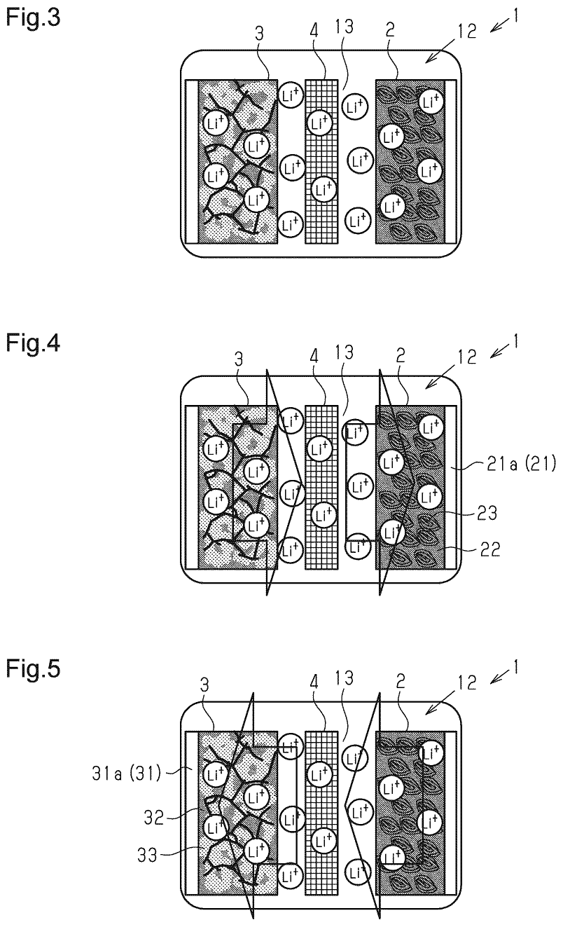

FIG. 3 is a schematic diagram showing the lithium-ion rechargeable battery 1 of the present embodiment in a non-energized state. As shown in FIG. 3, in the electrode body 12 of the lithium-ion rechargeable battery 1, the cathode plate 3 and the anode plate 2 face each other with the separator 4 located in between. The space between the cathode plate 3 and the anode plate 2 is filled with a nonaqueous electrolyte solution 13 to allow for movement of the lithium ions Lit. In the non-energized state, the lithium ions Lit are not electrically induced to any one of the cathode plate 3 and the anode plate 2. This state is the same as the conventional lithium-ion rechargeable battery 101.

FIG. 4 is a schematic diagram showing the lithium-ion rechargeable battery 1 of the present embodiment when being charged. When the lithium-ion rechargeable battery 1 is charged, electrons are transferred from the anode connector 21a to the anode collector 21 in the anode plate 2. The electrons from the anode collector 21 are transferred to the anode active material 23. This attracts the lithium ions Li⁺ in the nonaqueous electrolyte solution 13 toward the anode active material 23.

In the present embodiment, the porosity SP (%) of the separator 4 is low to inhibit movement of the lithium ions Lit. Thus, the lithium ions Lit cannot easily move from the cathode plate 3 toward the anode plate 2.

Although a sufficient amount of the anode active material 23 has to be included in the anode mixture layer 22 of the anode plate 2 to increase the battery capacity, the porosity NP (%) is adjusted to be higher than that of the separator 4. Thus, during charging, the separator 4 limits excessive movement of the lithium ions Lit, and the concentration of lithium ions Lit in the surface of the anode mixture layer 22 will not become excessively high throughout the nonaqueous electrolyte solution 13. This keeps the concentration of lithium ions Li⁺ uniform. Thus, high rate deterioration is reduced.

FIG. 5 is a schematic diagram showing the lithium-ion rechargeable battery 1 of the present embodiment when being discharged. When the lithium-ion rechargeable battery 1 is discharged, electrons are transferred from the cathode connector 31a to the cathode collector 31 of the cathode plate 3. The electrons from the cathode collector 31 are transferred to the cathode active material 33. This attracts the lithium ions Li⁺ in the nonaqueous electrolyte solution 13 toward the cathode active material 33.

In the present embodiment, the porosity SP (%) of the separator 4 is low to inhibit movement of the lithium ions Lit. Thus, the lithium ions Lit cannot easily move from the anode plate 2 toward the cathode plate 3.

Preferably, a sufficient amount of the cathode active material 33 is included in the cathode mixture layer 32 of the cathode plate 3 to increase the battery capacity. The porosity PP (%), however, is adjusted to be higher than that of the separator 4. Thus, during discharging, the separator 4 limits excessive movement of the lithium ions Lit, and the concentration of lithium ions Lit in the surface of the cathode mixture layer 32 will not become excessively high. This keeps the concentration of lithium ions Li⁺ uniform throughout the nonaqueous electrolyte solution 13. Thus, high rate deterioration is also reduced in this case.

### Structure of Present Embodiment

The structure of the lithium-ion rechargeable battery 1 will now be described in detail.

### Structure of Lithium-Ion Rechargeable Battery 1

The lithium-ion rechargeable battery 1 of the present embodiment and one example of the separator 4 will now be described.

FIG. 1 is a schematic perspective view showing the lithium-ion rechargeable battery 1 of the present embodiment. As shown in FIG. 1, the lithium-ion rechargeable battery 1 serves as a battery cell. The lithium-ion rechargeable battery 1 includes a box-shaped battery case 11 having an open upper end. The battery case 11 accommodates an electrode body 12. The nonaqueous electrolyte solution 13 is injected into the battery case 11 through a liquid inlet. The battery case 11 is a sealed battery jar formed from a metal such as an aluminum alloy. The lithium-ion rechargeable battery 1 includes a cathode external terminal 14 and an anode external terminal 15 used to charge and discharge electric power. The cathode external terminal 14 and the anode external terminal 15 do not have to be shaped as shown in FIG. 1.

### Electrode Body 12

FIG. 2 is a schematic diagram showing the electrode body 12, which is rolled. The electrode body 12 is formed by rolling the anode plate 2, the cathode plate 3, and the separator 4 into a relatively flat shape so that the separator 4 is arranged between layers of the anode plate 2 and the cathode plate 3. The anode plate 2 is formed by applying the anode mixture layer 22 to the anode collector 21, which serves as a base material. The anode connector 21a is defined by one end of the anode plate 2 in the widthwise direction W (direction of rolling axis), which is orthogonal to a rolling direction L, where the anode mixture layer 22 is not applied to and the anode collector 21 is exposed.

### Stacked Structure of Electrode Body 12

As shown in FIG. 2, the electrode body 12 of the lithium-ion rechargeable battery 1 basically includes the anode plate 2, the cathode plate 3, and the separator 4.

The anode plate 2 includes the anode mixture layer 22 on the two opposite surfaces of the anode collector 21, which serves as an anode base material. One end of the anode collector 21 serves as the anode connector 21a where metal is exposed.

The cathode plate 3 includes the cathode mixture layer 32 on the two opposite surfaces of the cathode collector 31, which serves as the cathode base material. One end of the cathode collector 31 at the side of the electrode body 12 opposite the anode connector 21a serves as the cathode connector 31a where metal is exposed.

A stack of the anode plate 2 and the cathode plate 3 is formed with the separator 4 located in between. The stack is rolled in the longitudinal direction about the rolling axis and then flattened to form the electrode body 12.

### Nonaqueous Electrolyte Solution 13

Referring to FIG. 1, the battery jar, which is defined by the battery case 11, is filled with the nonaqueous electrolyte solution 13. The nonaqueous electrolyte solution 13 of the lithium-ion rechargeable battery 1 is a composition in which lithium salt is dissolved in an organic solvent. The lithium salt may be LiClO₄, LiPF₆, LiAsF₆, LiBF₄, SO₃CF₃ or the like. Examples of the organic solvent include a cyclic carbonate such as ethylene carbonate (EC), propylene carbonate (PC), butylene carbonate, and trifluoropropylene carbonate (TFPC); a chain carbonate such as diethyl carbonate (DEC), dimethyl carbonate (DMC), ethyl methyl carbonate (EMC), and dipropyl carbonate (DPC); an ether compound such as tetrahydrofuran (TFH), 2-methyltetrahydrofuran (2-MeTHF), and dimethoxyethane; a sulfur compound such as ethyl methyl sulfone and butanesultone; a phosphorous compound such as triethyl phosphate and trioctyl phosphate. One of these compounds or a mixture of more than one of these compounds may be used as the nonaqueous electrolyte solution 13. Nevertheless, the composition of the nonaqueous electrolyte solution 13 is not limited to the compounds listed above.

### Elements of Electrode Body 12

The elements of the electrode body 12, namely, the anode plate 2, the cathode plate 3, and the separator 4, will now be described.

In this specification, “average particle size” will refer to the median size (D₅₀: 50% volume average particle size) corresponding to the cumulative frequency of 50% in a volume-based particle size distribution unless otherwise indicated. The average particle diameter may be obtained through a laser diffraction-light scattering method when the average particle diameter is 1 μm or greater. Further, the average particle diameter may be obtained through a dynamic light scattering (DLS) method when the average particle diameter is 1 μm or less. The average diameter obtained through the DLS method is in compliance with JIS Z 8828:2013.

### Anode Plate 2

The anode mixture layer 22 is formed on the two opposite surfaces of the anode collector 21, which is an anode base material, to form the anode plate 2. In the present embodiment, the anode collector 21 is formed by a Cu foil. The anode collector 21 serves as a base for the anode mixture layer 22 and has the functionality of a collecting member for collecting electricity from the anode mixture layer 22. In the present embodiment, the anode active material 23, which allows for the storage and release of lithium ions, is a powdered carbon material of graphite or the like.

The anode mixture layer 22 of the anode plate 2 is formed by, for example, kneading the anode active material 23, the solvent, and the binder into an anode mixture paste, which is then applied to and dried on the anode collector 21.

### Cathode Plate 3

As shown in FIG. 2, the cathode plate 3 includes the cathode collector 31 and the cathode mixture layer 32, which is applied to the cathode collector 31.

### Cathode Collector 31

The cathode mixture layer 32 is formed on the two opposite surfaces of the cathode collector 31, which is a cathode base material, to form the cathode plate 3. In the present embodiment, the cathode collector 31 is formed by an aluminum foil. The cathode collector 31 serves as a base for the cathode mixture layer 32 and has the functionality of a collecting member for collecting electricity from the cathode mixture layer 32.

The cathode collector 31, which is the cathode base material, is exemplified as an aluminum foil but may be formed by, for example any conductive material of metal having satisfactory conductivity. The conductive material may be, for example, a material containing aluminum or a material containing an aluminum alloy. Nevertheless, the cathode collector 31 is not limited to the structure described above.

### Cathode Mixture Layer 32

A cathode mixture paste is applied to and dried on the cathode collector 31 to form the cathode mixture layer 32. The cathode mixture layer 32 includes a conductive material, a binder, and a dispersant in addition to the cathode active material 33.

### Composition of Cathode Active Material 33

The particles of the cathode active material 33 contain lithium transition metal oxide having a layered crystal structure. This, however, is not a limitation. In addition to Li, the lithium transition metal oxide contains one or more predetermined transition metal elements. Preferably, the transition metal elements contained in the lithium transition metal oxide is at least one of Ni, Co, and Mn. One preferred example of the lithium transition metal oxide includes every one of Ni, Co, and Mn.

In addition to the lithium transition metal oxide (i.e., at least one of Ni, Co, and Mn), the cathode active material 33 may also contain one or more elements. Examples of such an additional element of the cathode active material 33 include may be any element in the periodic table belonging to group 1 (alkali metal such as sodium), group 2 (alkaline earth metal such as magnesium and calcium), group 4 (transition metal such as titanium and zirconium), group 6 (transition metal such as chromium and tungsten), group 8 (transition metal such as iron), group 13 (semi-metal such as boron or metal such as aluminum), and group 17 (halogen such as fluorine).

### Binder

The binder may be, for example, polyvinylidene fluoride (PVdF), polytetrafluoroethylene (PTFE), polyacrylic acid, or polyacrylate.

### Features of Lithium-Ion Rechargeable Battery 1

The lithium-ion rechargeable battery 1 of the present embodiment basically includes the electrode body 12 formed by the stack of the cathode plate 3 having the cathode mixture layer 32, the anode plate 2 having the anode mixture layer 22, and the separator 4 arranged between the cathode plate 3 and the anode plate 2. The porosity PP of the cathode mixture layer 32 and the porosity NP of the anode mixture layer 22 are each set to be higher than the porosity SP of the separator 4.

As a result, the separator 4 limits the movement of the lithium ions Lit in the lithium-ion rechargeable battery 1. More specifically, the porosity PP of the cathode mixture layer 32 and the porosity NP of the anode mixture layer 22 are each set to be higher than the porosity SP of the separator 4 so that the speed at which the lithium ions L⁺ move is determined by the separator 4. This limits movement of the lithium ions Li⁺ and avoids uneven concentration of the lithium ions Lit.

### Porosity SP of Separator 4

In the present embodiment, the porosity SP of the separator 4 is adjusted to be 42.15% or less. When the porosity SP is 42.15% or less, the movement of the lithium ions Lit can be effectively limited, and uneven concentration of the lithium ions Li⁺ in the nonaqueous electrolyte solution 13 can be avoided.

Preferably, the porosity SP of the separator 4 is 39.54% or greater. When the porosity SP is 39.54% or greater, passage of the lithium ions Li⁺ will not be overly impeded.

### Porosity PP of Cathode Mixture Layer 32

In the present embodiment, the porosity PP of the cathode mixture layer 32 is adjusted to be 44.16% or greater. When the porosity PP is 44.16% or greater, uneven concentration of the lithium ions Lit can be effectively avoided.

Preferably, the porosity PP of the cathode mixture layer 32 is 48.61% or less. When the porosity PP is 48.61% or less, the required battery capacity will be obtained.

The density of the cathode mixture layer 32 is 2.9 g/cm³ or less. When the density of the cathode mixture layer 32 is 2.9 g/cm³ or less, the porosities described above can be obtained.

The density of the cathode mixture layer 32 is adjusted to be 2.2 g/cm³ or greater. When the density of the cathode mixture layer 32 is 2.2 g/cm³ or greater, the required battery capacity will be obtained.

### Porosity NP of Anode Mixture Layer 22

In the present embodiment, the porosity NP of the anode mixture layer 22 is adjusted to be 45.38% or greater. When the porosity NP is 45.38% or greater, uneven concentration of the lithium ions Lit can be effectively avoided.

Preferably, the porosity NP of the anode mixture layer 22 is 49.88% or less. When the porosity NP of the anode mixture layer 22 is 49.88% or less, the required battery capacity will be obtained.

The density of the anode mixture layer 22 is 1.2 g/cm³ or less. When the density of the anode mixture layer 22 is 1.2 g/cm³ or less, the porosity NP will be sufficient.

The density of the anode mixture layer 22 is adjusted to be 0.9 g/cm³ or greater. When the density of the anode mixture layer 22 is 0.9 g/cm³ or greater, the required battery capacity will be obtained.

### Spring Constant C of Battery Cell

The “spring constant C kN/mm” of the battery cell as referred to in the present embodiment will now be described. The “spring constant C kN/mm” as referred to in the present embodiment is measured through the following procedures. The lithium-ion rechargeable battery 1 (battery cell) is pressed by a load cell in the thickness direction of the battery cell with a load of 9.8 kN. Then, the load of the load cell is decreased to 4.5 kN. As a result, the cell that was compressed together with the electrode body 12 under the load of 9.8 kN will restore its thickness due to elasticity. The displacement amount in this state is represented by D (mm). The load cell is held in place at this position, and the battery cell is left standing for 600 seconds. As a result, the spring back of the electrode body 12 over time will mainly cause the battery cell to push back the load cell. This increases the load on the load cell that is held in place. The load on the load cell in this state is represented by L (kN). The spring constant C of the cell is obtained through the equation of C=(9.8-L)/D. In the present embodiment, the cell of the lithium-ion rechargeable battery 1 is adjusted to be C≤95.38 kN/mm.

The spring constant C of the cell is 95.38 kN/mm or less for the reasons described below. High rate charging and discharging will change the thickness of the anode mixture layer 22 in the lithium-ion rechargeable battery 1. In this case, when the spring constant C is large, that is, when the electrode body 12 is hard, the nonaqueous electrolyte solution 13 will not be stored inside the electrode body 12. Thus, the flow of the nonaqueous electrolyte solution 13 into and out of the electrode body 12 will cause the concentration of the lithium ions Lit inside the electrode body 12 to become uneven. When the spring constant C is 95.38 kN/mm or less, the electrode body 12 is flexible, and the nonaqueous electrolyte solution 13 can be stored in the electrode body 12. This limits sudden flow of the nonaqueous electrolyte solution 13 into and out of the electrode body 12. Thus, the concentration of the lithium ions Li⁺ in the nonaqueous electrolyte solution 13 will remain uniform. Consequently, high rate deterioration can be reduced.

Preferably, the spring constant C is set to be C≥84.96 kN/mm. When the spring constant C kN/mm is 84.96 kN/mm or greater, the battery cell will have sufficient hardness. This will increase the stability of a battery module, which stacks battery cells in the thickness direction, and a battery pack, which is formed by battery modules.

### Difference ΔP

The “difference ΔP” (PPD-NPD porosity difference ΔP) as referred to in the present embodiment will now be described. The “difference ΔP” as referred to in the present embodiment is calculated through the following procedures. The difference between the porosity PP of the cathode mixture layer 32 and the porosity SP of the separator 4 is referred to as the PP-SP porosity difference PPD (cathode porosity difference). The difference between the porosity NP of the anode mixture layer 22 and the porosity SP of the separator 4 is referred to as the NP-SP porosity difference NPD (anode porosity difference). The difference between the PP-SP porosity difference PPD and the NP-SP porosity difference NPD is referred to as the difference ΔP. The difference ΔP can be expressed as follows.

$$\begin{matrix}Difference Δ P = ( PP - SP porosity difference PPD ) - ( NP - SP porosity difference NPD ) \\ = ( porosity PP - porosity SP ) - ( porosity NP - porosity SP ) \\ = porosity PP - porosity NP\end{matrix}$$

The difference ΔP is the difference between the porosity PP of the cathode mixture layer 32 and the porosity NP of the anode mixture layer 22. When the difference ΔP is 0, the porosity PP is equal to the porosity NP. In this embodiment, the difference ΔP is adjusted to be less than 4%. When the difference ΔP is less than 4%, the difference in porosity between the cathode mixture layer 32 and the separator 4 will be approximate to the difference in porosity between the anode mixture layer 22 and the separator 4. With such a configuration, regardless of whether charging or discharging is performed, the concentration of the lithium ions Lit will be uniform, and the lithium ions Li⁺ will be able to move smoothly. This will effectively reduce high rate deterioration in the entirety of the lithium-ion rechargeable battery 1.

### Method for Manufacturing Separator 4

One example of a method for manufacturing the separator 4 having the features described above will now be described. The method for manufacturing the lithium-ion rechargeable battery 1 in accordance with the present embodiment is not limited to the present embodiment.

The separator 4 is formed by a thin film of a polyolefin such a polyethylene (PE) or polypropylene (PP). In the present embodiment, the separator 4 has a three-layer structure constructed by a polyethylene core sheet, a polypropylene sheet adhered to cathode side of the core sheet, and a polypropylene sheet adhered to the anode side of the core sheet.

Each sheet, which is porous and elongated, is pulled out from a roll in a longitudinal direction and stretched in the longitudinal direction. Each sheet is also stretched in a direction orthogonal to the longitudinal direction. The stretching process including such biaxial stretching enlarges pores in the direction orthogonal to the longitudinal direction. The stretching process adjusts the pores and the porosity P (%) of the polypropylene cathode sheet and the polypropylene anode sheet. The separator 4 may have a single-layer structure.

### Method for Manufacturing Cathode Plate 3

The cathode mixture layer 32 of the cathode plate 3 is formed through the following process. The cathode active material 33, a conductive material 34, a binder, an organic solvent, and an additive are first kneaded into a cathode mixture paste that forms the cathode mixture layer 32. The porosity PP (%) is varied in accordance with the type of the conductive material 34 that is selected. In the present embodiment, carbon nanotubes or carbon nanofibers having a specific surface area of BET 150 to 300 m²/g are used as the conductive material 34. This allows for the formation of an effective conductive network, even when the amount of carbon nanotubes or carbon nanofibers is small. Thus, the porosity PP (%) can be increased.

After the application of the cathode mixture paste, the pressing force and pressing speed are adjusted to control the density and thickness of the cathode mixture layer 32 and adjust the porosity PP (%). In the present embodiment, the pressing force is 50 to 196 kN, and the pressing speed is 6 to 60 m/min.

### Method for Manufacturing Anode Plate 2

The anode mixture layer 22 of the anode plate 2 is formed in the following manner. The anode active material 23, the conductive material 34, a binder, an organic solvent, and an additive are first kneaded into an anode mixture paste that forms the anode mixture layer 22. The anode mixture layer 22 of the anode plate 2 is a slurry containing graphite, a binder (SBR, SAR, or the like), and a thickener (CMC or the like). Shearing force is applied to the slurry so that the slurry has a certain blackness (controlled powder amount). After the application of the anode mixture paste, the pressing force and the pressing speed are adjusted to control the density and thickness of the anode mixture layer 22 and adjust the porosity NP (%). In the present embodiment, the pressing force is 50 to 196 kN, and the pressing speed is 6 to 60 m/min.

### Experimental Examples

### Experiment Conditions

Experiments were conducted on experimental samples to first measure the porosity PP of the cathode mixture layer 32, the porosity NP of the anode mixture layer 22, and the porosity SP of the separator 4.

The high rate characteristic was evaluated using a high rate deterioration resistance increase rate. The high rate deterioration resistance increasing rate is the increase rate of the internal resistance (CD-IR), after performing a charge-discharge cycle test that repeats charging and discharging with a large current (several tens of amperes or greater) for a certain time, from the internal resistance (CD-IR) prior to the charge-discharge cycle test.

It was found through the experiments that the high rate characteristic of 1.124 or less was tolerable. The high rate characteristic is indicated by a high rate characteristic index HI in which the high rate characteristic of 1.124 is equivalent to the base of 1.000. The high rate characteristic index HI allows the high rate characteristic to be simply expressed by a numerical value.

The PP-SP porosity difference PPD is a value indicating the difference between the porosity PP of the cathode mixture layer 32 and the porosity SP of the separator 4. The NP-SP porosity difference NPD is a value indicating the difference between the porosity NP of the anode mixture layer 22 and the porosity SP of the separator 4.

A PPD-NPD porosity difference ΔP is a value indicating the difference between the PP-SP porosity difference PPD and the NP-SP porosity difference NPD.

When the spring constant C (kN/mm) is too high, the electrode body 12 will be hard and the nonaqueous electrolyte solution 13 will be difficult to store. This tends to cause high rate deterioration. When the spring constant C (kN/mm) is too low, the stability of stacked cells will decrease.

### Evaluation Criterion for Experiments

The experiments were evaluated using the high rate characteristic index HI.

### Conditions and Results of Examples 1 to 6 and Comparative Examples 1 to 6

In example 1, the porosity PP of the cathode mixture layer 32 was 44.16%, the porosity NP of the anode mixture layer 22 was 47.41%, and the porosity SP of the separator 4 was 41.49%. Further, the high rate characteristic was 1.07, which is equivalent to 1.05 when converted into the high rate characteristic index HI.

The PP-SP porosity difference PPD, which is the difference between the porosity PP of the cathode mixture layer 32 and the porosity SP of the separator 4, was 2.67%.

The NP-SP porosity difference NPD, which is the difference between the porosity NP of the anode mixture layer 22 and the porosity SP of the separator 4, was 5.92%.

The PPD-NPD porosity difference ΔP, which is the difference between the PP-SP porosity difference PPD and the NP-SP porosity difference NPD, was 3.24%.

The spring constant C was 85.42 kN/mm.

In example 2, the porosity PP of the cathode mixture layer 32 was 44.16%, the porosity NP of the anode mixture layer 22 was 47.41%, and the porosity SP of the separator 4 was 42.15%. Further, the high rate characteristic was 1.08, and the high rate characteristic index HI was 1.04. The PP-SP porosity difference PPD was 2.01%, and the NP-SP porosity difference NPD was 5.26%. The PPD-NPD porosity difference ΔP was 3.24%. The spring constant C was 84.96 kN/mm.

In example 3, the porosity PP of the cathode mixture layer 32 was 43.42%, the porosity NP of the anode mixture layer 22 was 45.38%, and the porosity SP of the separator 4 was 41.42%. Further, the high rate characteristic was 1.08, and the high rate characteristic index HI was 1.04. The PP-SP porosity difference PPD was 2.00%, and the NP-SP porosity difference NPD was 3.96%. The PPD-NPD porosity difference ΔP was 1.96%. The spring constant C was 91.48 kN/mm.

In example 4, the porosity PP of the cathode mixture layer 32 was 44.16%, the porosity NP of the anode mixture layer 22 was 46.16%, and the porosity SP of the separator 4 was 39.88%. Further, the high rate characteristic was 1.10, and the high rate characteristic index HI was 1.02. The PP-SP porosity difference PPD was 4.29%, and the NP-SP porosity difference NPD was 6.28%. The PPD-NPD porosity difference ΔP was 2.00%. The spring constant C was 92.38 kN/mm.

In example 5, the porosity PP of the cathode mixture layer 32 was 44.16%, the porosity NP of the anode mixture layer 22 was 46.16%, and the porosity SP of the separator 4 was 39.54%. Further, the high rate characteristic was 1.11, and the high rate characteristic index HI was 1.01. The PP-SP porosity difference PPD was 4.63%, and the NP-SP porosity difference NPD was 6.63%. The PPD-NPD porosity difference ΔP was 2.00%. The spring constant C was 95.38 kN/mm.

In example 6, the porosity PP of the cathode mixture layer 32 was 48.61%, the porosity NP of the anode mixture layer 22 was 49.88%, and the porosity SP of the separator 4 was 42.02%. Further, the high rate characteristic was 1.11, and the high rate characteristic index HI was 1.01. The PP-SP porosity difference PPD was 6.59%, and the NP-SP porosity difference NPD was 7.86%. The PPD-NPD porosity difference ΔP was 1.26%. The spring constant C was 86.41 kN/mm.

In comparative example 1, the porosity PP of the cathode mixture layer 32 was 38.05%, the porosity NP of the anode mixture layer 22 was 48.04%, and the porosity SP of the separator 4 was 41.64%. Further, the high rate characteristic was 1.16, and the high rate characteristic index HI was 0.97. The PP-SP porosity difference PPD was-3.59%, and the NP-SP porosity difference NPD was 6.41%. The PPD-NPD porosity difference ΔP was 9.99%. The spring constant C was 94.00 kN/mm.

In comparative example 2, the porosity PP of the cathode mixture layer 32 was 43.99%, the porosity NP of the anode mixture layer 22 was 39.58%, and the porosity SP of the separator 4 was 41.05%. Further, the high rate characteristic was 1.15, and the high rate characteristic index HI was 0.98. The PP-SP porosity difference PPD was 2.94%, and the NP-SP porosity difference NPD was-1.47%. The PPD-NPD porosity difference ΔP was 4.41%. The spring constant C was 92.83 kN/mm.

In comparative example 3, the porosity PP of the cathode mixture layer 32 was 44.45%, the porosity NP of the anode mixture layer 22 was 47.39%, and the porosity SP of the separator 4 was 48.15%. Further, the high rate characteristic was 1.17, and the high rate characteristic index HI was 0.96. The PP-SP porosity difference PPD was-3.70%, and the NP-SP porosity difference NPD was-0.76%. The PPD-NPD porosity difference ΔP was 2.94%. The spring constant C was 88.80 kN/mm.

In comparative example 4, the porosity PP of the cathode mixture layer 32 was 45.04%, the porosity NP of the anode mixture layer 22 was 45.38%, and the porosity SP of the separator 4 was 46.41%. Further, the high rate characteristic was 1.17, and the high rate characteristic index HI was 0.96. The PP-SP porosity difference PPD was-1.37%, and the NP-SP porosity difference NPD was-1.02%. The PPD-NPD porosity difference ΔP was 0.34%. The spring constant C was 87.93 kN/mm.

In comparative example 5, the porosity PP of the cathode mixture layer 32 was 46.04%, the porosity NP of the anode mixture layer 22 was 46.12%, and the porosity SP of the separator 4 was 49.30%. Further, the high rate characteristic was 1.34, and the high rate characteristic index HI was 0.84. The PP-SP porosity difference PPD was-3.26%, and the NP-SP porosity difference NPD was-3.18%. The PPD-NPD porosity difference ΔP was 0.08%. The spring constant C was 98.48 kN/mm.

### Conclusion of Experiments

### High Rate Characteristic Index HI

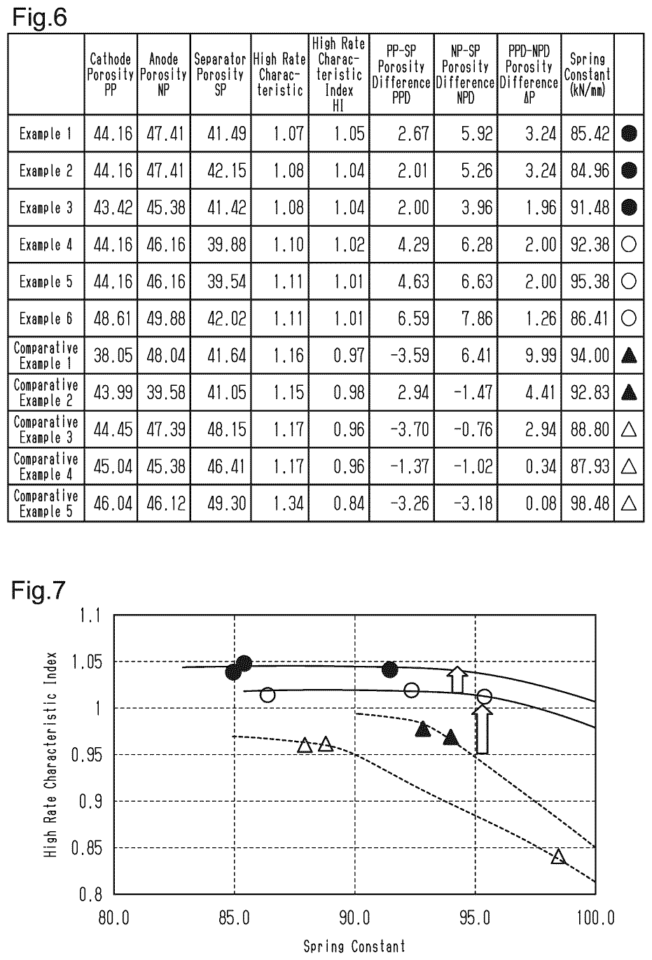

The facts found from the experiments are described below. The present invention will first be evaluated using the high rate characteristic index HI. As shown in the table of FIG. 6, each of examples 1 to 3, which are indicated by the black circles, had a high rate characteristic index HI in the range from 1.05 to 1.04 and obtained a particularly satisfactory result. Each of examples 4 to 6, which are indicated by white circles, had a high rate characteristic index HI in the range from 1.02 to 1.01 that was less satisfactory.

Each of comparative examples 1 and 2, which are indicated by black triangles, had a high rate characteristic index HI in the range from 0.97 to 0.98, which is a relatively low range. Each of comparative examples 3 to 5, which are indicated by the white triangles, had a high rate characteristic index HI in the range from 0.84 to 0.96, which shows that the deterioration was great.

### Porosity SP, Porosity PP, and Porosity NP

In examples 1 to 6, the porosity PP of the cathode mixture layer 32 and the porosity NP of the anode mixture layer 22 were greater than the porosity SP of the separator 4. In comparative examples 1 to 5, the porosity PP of the cathode mixture layer 32 and/or the porosity NP of the anode mixture layer 22 were less than the porosity SP of the separator 4. It can thus be understood that high rate deterioration was reduced when the porosity PP of the cathode mixture layer 32 and the porosity NP of the anode mixture layer 22 were greater than the porosity SP of the separator 4.

### Porosity PP of Cathode Mixture Layer 32

In examples 1 to 6, the porosity PP of the cathode mixture layer 32 was in the range from 44.16% to 48.61%, and the high rate characteristic index was satisfactory. Thus, the preferable range of the porosity PP of the cathode mixture layer 32 is from 44.16% to 48.61%.

### Porosity NP of Anode Mixture Layer 22

In examples 1 to 6, the porosity NP of the anode mixture layer 22 was in the range of 45.38% to 49.88%, and the high rate characteristic index was satisfactory. Thus, the preferable range of the porosity NP of the anode mixture layer 22 is from 45.38% to 49.88%.

### Porosity SP of Separator 4

In examples 1 to 6, the porosity SP of the separator 4 was in the range of 39.54% to 42.15%, and the high rate characteristic index was satisfactory. Thus, the preferable range of the porosity SP of the separator 4 is from 39.54% to 42.15%.

### Difference ΔP

In examples 1 to 6, the difference ΔP was in the range of 1.26% to 3.24%, and the high rate characteristic index was satisfactory. Thus, the preferable range of the difference ΔP is from 1.26% to 3.24%.

### Spring Constant C

In examples 1 to 6, the spring constant C (kN/mm) was in the range of 84.96 to 95.38 kN/mm. Thus, the preferable range of the spring constant C is from 84.96 to 95.38 kN/mm.

### Operation of Present Embodiment

The operation of the lithium-ion rechargeable battery 1 will now be described. Referring to FIG. 4, when the lithium-ion rechargeable battery 1 is charged, electrons are transferred from the anode collector 21 to the anode active material 23. This attracts the lithium ions Li⁺ in the nonaqueous electrolyte solution 13 toward the anode active material 23.

In the present embodiment, the porosity SP (%) of the separator 4 is low to inhibit movement of the lithium ions Lit. Thus, the lithium ions Lit cannot easily move from the cathode plate 3 toward the anode plate 2. The separator 4 limits the movement of the lithium ions Lit. Thus, excessive movement of the lithium ions Li⁺ will be avoided, and the concentration of lithium ions Lit in the surface of the anode mixture layer 22 will not become excessively high throughout the nonaqueous electrolyte solution 13. This keeps the concentration of lithium ions Lit uniform. Thus, high rate deterioration is reduced.

Further, as shown in FIG. 5, during discharging, in the same manner, the separator 4 limits the movement of the lithium ions Lit. Thus, the concentration of lithium ions Li⁺ in the surface of the cathode mixture layer 32 will not become excessively high. This keeps the concentration of lithium ions Li⁺ uniform throughout the nonaqueous electrolyte solution 13. Thus, high rate deterioration is also reduced in this case.

In the lithium-ion rechargeable battery 1 of the present embodiment, regardless of whether charging or discharging is performed, the concentration of lithium ions Li⁺ will be uniform and be in a range that allows the lithium ions Lit to move smoothly. Further, the spring constant C is adjusted so that the concentration of lithium ions Li⁺ in the nonaqueous electrolyte solution 13 will remain uniform. As a result, when high rate charging or discharging is performed, high rate deterioration of the lithium-ion rechargeable battery 1 will be reduced.

### Advantages of Present Embodiment

(1) The lithium-ion rechargeable battery of the present embodiment reduces high rate deterioration.

(2) The porosity PP of the cathode mixture layer 32 and the porosity NP of the anode mixture layer 22 are each greater than the porosity SP of the separator 4. Thus, the concentration of the lithium ions Li⁺ will remain uniform in the surfaces of the cathode plate 3 and the anode plate 2.

(3) The difference ΔP of the PP-SP porosity difference PPD, between the porosity PP of the cathode mixture layer 32 and the porosity SP of the separator 4, and the NP-SP porosity difference NPD, between the porosity NP of the anode mixture layer 22 and the porosity SP of the separator 4, is 4% or less. This allows the lithium ions Lit to be concentrated uniformly and circulated smoothly in the cathode plate 3 and the anode plate 2.

(4) The PP-SP porosity difference PPD is in the range from 2.00% to 6.59%. This allows the lithium ions Lit to be concentrated uniformly and circulated smoothly in the cathode plate 3.

(5) The NP-SP porosity difference NPD is in the range from 3.96% to 7.86%. This allows the lithium ions Lit to be concentrated uniformly and circulated smoothly in the anode plate 2.

(6) The porosity SP of the separator 4 is 42.15% or less. This allows the lithium ions Lit to be concentrated uniformly in the anode plate 2.

(7) The porosity SP of the separator 4 is 39.54% or greater. This allows the lithium ions Li⁺ to be circulated smoothly in the anode plate 2.

(8) The porosity PP is 44.16% or greater. This allows the lithium ions Lit to be concentrated uniformly in the cathode plate 3.

(9) The porosity PP is 48.61% or less. This obtains a sufficient battery capacity.

(10) The porosity NP is 45.38% or greater. This allows the lithium ions Lit to be concentrated uniformly in the anode plate 2.

(11) The porosity NP is 49.88% or less. This obtains a sufficient battery capacity.

(12) The density of the cathode mixture layer 32 is 2.9 g/cm³ or less. This allows the cathode mixture layer 32 to have a sufficient porosity.

(13) The density of the cathode mixture layer 32 is 2.2 g/cm³ or greater. This obtains a sufficient battery capacity.

(14) The density of the anode mixture layer 22 is 1.2 g/cm³ or less. This allows the anode mixture layer 22 to have a sufficient porosity.

(15) The density of the anode mixture layer 22 is 0.9 g/cm³ or greater. This obtains a sufficient battery capacity.

(16) The load cell presses the lithium-ion rechargeable battery 1 with a load of 9.8 kN in the thickness direction and the load is then changed to 4.5 kN. The displacement amount in this state is represented by D (mm), and the load cell is held in place under a load L (kN) for 600 seconds. When the spring constant C (kN/mm) of the battery cell is expressed as C=(9.8-L)/D, C≤95.38 kN/mm is satisfied. This will keep the concentration of the nonaqueous electrolyte solution 13 uniform during charging and discharging.

(17) The spring constant C satisfies C≥84.96 kN/mm. This increases the stability a battery pack formed by a stack of the lithium-ion rechargeable batteries 1.

(18) While adjusting the spring constant C, the porosity PP of the cathode mixture layer 32 and the porosity NP of the anode mixture layer 22 are set to be greater than the porosity SP of the separator 4. This increases the degree of freedom for the numerical values that are set and improves productivity.

### Modified Examples

The above embodiment may be modified as described below.

The porosities P (%) and densities g/cm³ described above are examples used to illustrate the manufacturing method and are not intended to limit the present invention.

In the present embodiment, the lithium-ion rechargeable battery 1, which is a relatively flat battery cell for use in a vehicle, is described as an example of a nonaqueous electrolyte rechargeable battery. Instead, the lithium-ion rechargeable battery 1 may have a different shape, such as a cylindrical shape, and be used for other purposes, such as a stationary battery. Further, the electrode body 12 does not have to be a roll type that is relatively flat and may be formed by a stack of rectangular plate-like electrodes. Additionally, there is no limitation to the shapes of the cathode external terminal 14 and the anode external terminal 15.

Elements in the figures are illustrated for simplicity and clarity and have not necessarily been drawn to scale.

The numerical values and ranges described above are merely examples, and may be optimized by a person skilled in the art.

The compositions of the cathode mixture layer 32 and the anode mixture layer 22 and the characteristics of the material described above are examples of the present invention, and may be optimized by a person skilled in the art.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A lithium-ion rechargeable battery, comprising:
an electrode body including a stack of a cathode plate having a cathode mixture layer, an anode plate having an anode mixture layer, and a separator arranged between the anode plate and the cathode plate,
wherein a porosity PP of the cathode mixture layer and a porosity NP of the anode mixture layer are set to be greater than a porosity SP of the separator.

2. The lithium-ion rechargeable battery according to claim 1, wherein
a difference PPD is a difference between the porosity PP of the cathode mixture layer and the porosity SP of the separator,
a difference NPD is a difference between the porosity NP of the anode mixture layer and the porosity SP of the separator, and
a difference ΔP, which is a difference between the difference PPD and the difference NPD, is 4% or less.

3. The lithium-ion rechargeable battery according to claim 2, wherein the difference PPD is 2.00% to 6.59%.

4. The lithium-ion rechargeable battery according to claim 2, wherein the difference NPD is 3.96% to 7.86%.

5. The lithium-ion rechargeable battery according to claim 1, wherein the porosity SP of the separator is 42.15% or less.

6. The lithium-ion rechargeable battery according to claim 5, wherein the porosity SP of the separator is 39.54% or greater.

7. The lithium-ion rechargeable battery according to claim 1, wherein the porosity PP of the cathode mixture layer is 44.16% or greater.

8. The lithium-ion rechargeable battery according to claim 7, wherein the porosity PP of the cathode mixture layer is 48.61% or less.

9. The lithium-ion rechargeable battery according to claim 1, wherein the porosity NP of the anode mixture layer is 45.38% or greater.

10. The lithium-ion rechargeable battery according to claim 9, wherein the porosity NP of the anode mixture layer is 49.88% or less.

11. The lithium-ion rechargeable battery according to claim 1, wherein the cathode mixture layer has a density of 2.9 g/cm³ or less.

12. The lithium-ion rechargeable battery according to claim 11, wherein the density of the cathode mixture layer is 2.2 g/cm³ or greater.

13. The lithium-ion rechargeable battery according to claim 1, wherein the anode mixture layer has a density of 1.2 g/cm³ or less.

14. The lithium-ion rechargeable battery according to claim 13, wherein the density of the anode mixture layer is 0.9 g/cm³ or greater.

15. The lithium-ion rechargeable battery according to claim 1, wherein
a load cell presses the lithium-ion rechargeable battery with a load of 9.8 kN in a thickness direction of the lithium-ion rechargeable battery and the load is then changed to 4.5 kN,
a displacement amount in this state is represented by D mm,
the load of the load cell when the load cell is held in place and the lithium-ion rechargeable battery is left standing for 600 seconds is represented by L kN, and
when a spring constant of the lithium-ion rechargeable battery represented by C kN/mm is set to be C=(9.8-L)/D, C≤95.38 kN/mm is satisfied.

16. The lithium-ion rechargeable battery according to claim 15, wherein the spring constant C satisfies C≥84.96 kN/mm.
